(19) United States
(12) Patent Application Publication
(10) Pub. No.: US 2022/0001994 A1
(43) Pub. Date: Jan. 6, 2022

(54) DRONE HAVING PARACHUTE AND CONTROL METHOD THEREOF

(71) Applicant: Coretronic Intelligent Robotics Corporation, Hsin-Chu (TW)

(72) Inventors: Ying-Chieh Chen, Hsin-Chu (TW); Tai-Yuan Wang, Hsin-Chu (TW); I-Ta Yang, Hsin-Chu (TW); Chun-Hsu Lai, Hsin-Chu (TW)

(73) Assignee: Coretronic Intelligent Robotics Corporation, Hsin-Chu (TW)

(21) Appl. No.: 17/343,718

(22) Filed: Jun. 9, 2021

(30) Foreign Application Priority Data
Jul. 6, 2020 (CN) 202010640230.X

(51) Int. Cl. B64D 17/80; B64D 17/72; B64C 39/02

(52) U.S. Cl. CPC B64D 17/80; B64D 17/72; B64D 2045/0085; B64C 2201/185; B64C 39/024

(57) ABSTRACT

A drone includes a drone main body and a parachute module. The parachute module includes a base, a housing, an inflatable material, a parachute, and an inflating device. The base is disposed on the drone main body. The housing covers the base to form a containing space therebetween. The inflatable material is disposed on the base and furled in the containing space. The parachute is connected to the inflatable material and the housing and is furled in the containing space. The inflating device is disposed on the base and connected to the inflatable material. When the inflating device inflates the inflatable material, the inflatable material expands and strikes the housing, so that the housing is separated from the drone main body, so as to increase a distance between the parachute and the drone main body and deploy the parachute. In addition, a control method of the drone is also provided.

### CROSS-REFERENCE TO RELATED APPLICATION

This application claims the priority benefit of Chinese application serial no. 202010640230.X, filed on Jul. 6, 2020. The entirety of the above-mentioned patent application is hereby incorporated by reference herein and made a part of this specification.

### BACKGROUND

### Technical Field

The disclosure relates to an aircraft and a control method thereof, and particularly relates to a drone having a parachute and a control method thereof.

### Description of Related Art

Drones are usually controlled by means of remote control, a guidance system, or automated driving. The drones can serve for scientific research, site exploration, military, and entertainment purposes. Currently, the most commercialized unmanned vehicles are unmanned aerial vehicles. Aerial vehicles having a built-in or an external (video) camera are often called aerial cameras. The global market for the drones has grown substantially in recent years and the drones have now become an important tool for applications of commerce, the government, and consumption. The drones can support solutions in a variety of fields and are widely applied in construction, oil, natural gas, energy, agriculture, disaster relief, among other fields.

In order to prevent a falling drone from damaging or hurting people, a parachute may be disposed on the drone. However, during deployment of the parachute, if the drone is in a state of spinning out of control or at an insufficient height, it is possible that the parachute will be entangled with the drone body or cannot be deployed in time, thereby causing the drone to fall and damage or hurt other people.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The disclosure provides a drone having a parachute and a control method thereof, which may ensure a smooth deployment of a parachute of the drone.

The drone of the disclosure includes a drone main body and a parachute module. The parachute module includes a base, a housing, an inflatable material, a parachute, and an inflating device. The base is disposed on the drone main body. The housing covers the base to form a containing space between the housing and the base. The inflatable material is disposed on the base and is furled in the containing space. The parachute is connected to the inflatable material and the housing and is furled in the containing space. The inflating device is disposed on the base and is connected to the inflatable material. When the inflating device inflates the inflatable material, the inflatable material expands and strikes the housing to separate the housing from the drone main body, so that a distance between the parachute and the drone main body is increased and the parachute is driven to be deployed.

The control method of the drone of the disclosure includes the following steps. A parachute module is disposed a drone main body, in which the parachute module includes an inflating device, an inflatable material, a housing, and a parachute. The inflatable material is inflated by the inflating device to expand the inflatable material. The expanded inflatable material strikes the housing to separate the housing from the drone main body, so that a distance between the parachute which is connected to the housing and the inflatable material and the drone main body is increased and the parachute is driven to be deployed.

Based on the foregoing, in the drone of the disclosure, when the parachute module initiates the operation, the inflatable material expands and drives the parachute to move so that the parachute is separated from the drone main body at a suitable distance. It is accordingly possible to prevent that the parachute is unable to be smoothly deployed due to unexpected entangling with the drone main body. In addition, the housing configured to contain the parachute and the inflatable material moves along with the parachute as the inflatable material expands during the operation of the parachute module, which withstands turbulence and has a guiding effect of the deployment of the parachute. In this way, it can ensure that the parachute of the drone functions smoothly, and the time required for the full deployment of the parachute can be reduced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view drawing of a drone in an embodiment of the disclosure.

FIG. 2 is a schematic view drawing of the parachute module of FIG. 1.

FIG. 3 is a schematic view drawing showing the parachute module of FIG. 1 initiating operation.

FIG. 4 is a schematic view drawing showing the parachute of FIG. 2 being fully deployed.

FIG. 5 is a flowchart of a control method of the drone in the embodiments of the disclosure.

FIG. 6 is a schematic diagram of control of the parachute module.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

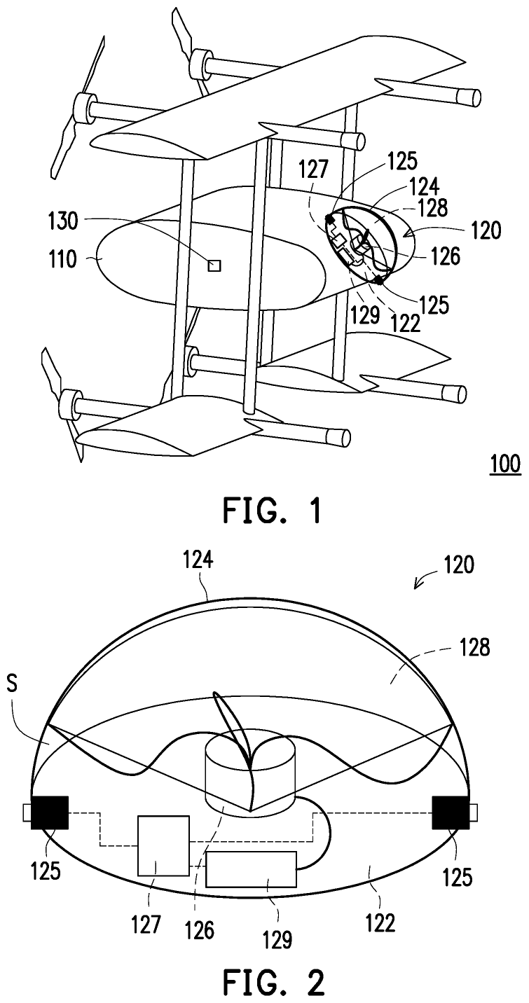

FIG. 1 is a schematic perspective view of a drone in an embodiment of the disclosure. FIG. 2 is a schematic view drawing of the parachute module of FIG. 1. Referring to FIG. 1 and FIG. 2, the drone 100 in this embodiment includes a drone main body 110 and a parachute module 120. The parachute module 120 includes a base 122, a housing 124, an inflatable material 126, a parachute 128, a controller 127, and an inflating device 129. The base 122 is disposed/fixed on an appropriate position on the drone main body 110. For example, the base 122 is disposed on an end of the drone main body 110 away from rotor blades, which effectively prevents the drone 100 from falling due to the parachute, when deployed, being entangled with the rotor blades. The housing 124 covers the base 122 to form a containing space S between the housing 124 and the base 122. The inflatable material 126 is disposed on the base 122 and is furled in the containing space S. The parachute 128 is connected to the inflatable material 126 and the housing 124 and is furled in the containing space S. The inflating device 129 is configured on the base 122 and connected to the inflatable material 126.

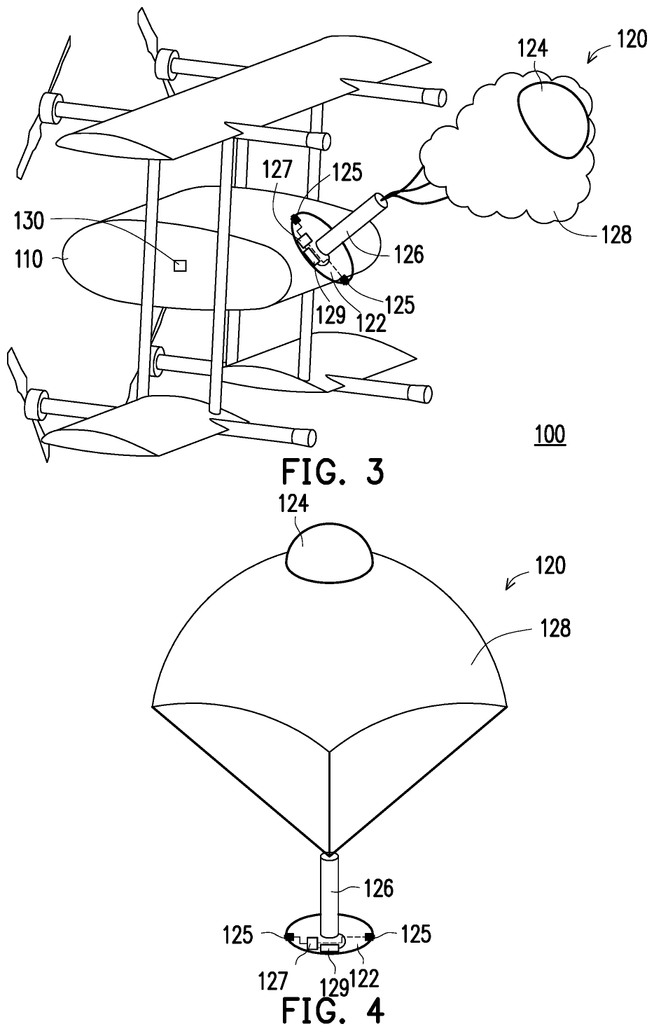

FIG. 3 is a schematic view drawing showing the parachute module of FIG. 1 initiating operation. FIG. 4 is a schematic view drawing showing the parachute of FIG. 2 being fully deployed. When the parachute module 120 initiates operation, the inflating device 129 inflates the inflatable material 126, and the inflatable material 126 expands into a column and strikes the housing 124 to separate the housing 124 from the drone main body 110, as shown in FIG. 3, so that a distance between the parachute 128 and the drone main body 110 is increased and the parachute 128 is driven to be deployed as shown in FIG. 4. Thereby, it is possible to prevent that the parachute 128 is unable to be smoothly deployed due to unexpected entangling with the drone main body 110 or the rotor blades of the drone main body 110. In addition, the housing 124 for containing the parachute 128 and the inflatable material 126 moves along with the parachute 128 as the inflatable material 126 expands as described above during the operation of the parachute module 120. Moreover, when the operation of the parachute module 120 has not been initiated, an outer surface of the housing 124 is, for example, a convex curved surface, or a streamlined design conforming to the shape of the drone main body 110. In this manner, not only is air flow disturbance or turbulence reduced when the drone 100 is flying, but there is also a guiding effect of the deployment direction of the parachute 128. In this way, it may be ensured that the parachute 128 of the drone 100 functions smoothly, and the time required for full deployment of the parachute 128 may be reduced.

FIG. 1 and FIG. 3 schematically illustrate a position of the parachute module 120 on the drone main body 110. The parachute module 120 may be mounted at other positions on the drone main body 110, and is not limited by the disclosure. For example, the parachute module 120 may be disposed at the end of the drone main body 110 away from the rotor blades or mounted near a gravity center of the drone main body 110, which effectively prevents the drone 100 from falling due to the parachute, when deployed, being entangled with the rotor blades.

In this embodiment, the inflatable material 126 is made of, for example, a woven fabric of a composite material with high mechanical properties, and has sufficient strength to withstand an impact of gas during inflation. The inflatable material 126 is employed to bounce the parachute 128 and the housing 124 off the drone main body 110. In other embodiments, the inflatable material 126 may be made of other suitable materials, and is not limited by the disclosure. In addition, the inflating device 129 in this embodiment is, for example, a high-pressure gas cylinder or other devices that may provide high-pressure gas, so that the inflatable material 126 may be inflated by the gas with high pressure.

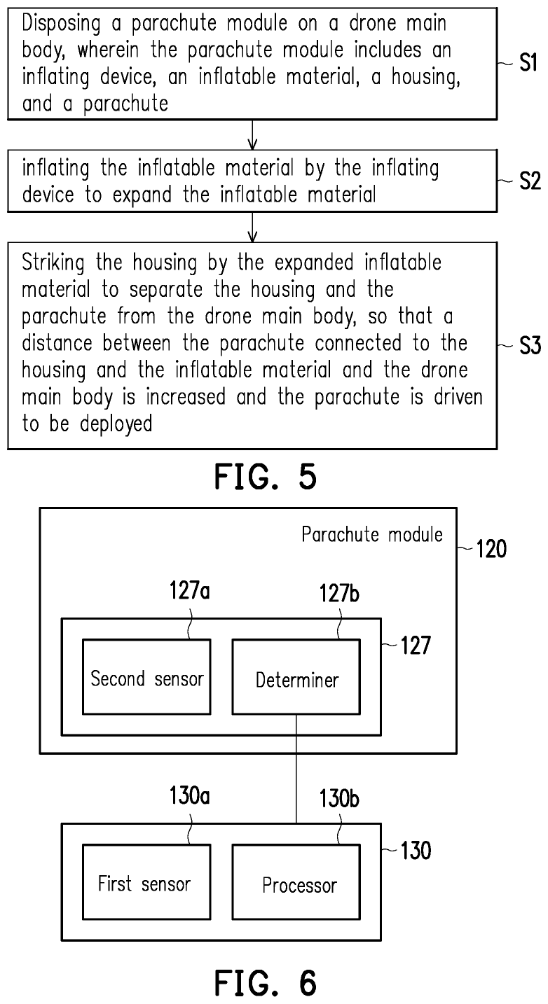

In the following, a control method of the parachute module of the drone in this embodiment is described through a flowchart. FIG. 5 is a flowchart of a control method of the drone in the embodiments of the disclosure. Referring to FIG. 5, firstly, a parachute module 120 is disposed on a drone main body 110, in which the parachute module 120 includes an inflating device 129, an inflatable material 126, a housing 124, and a parachute 128 (step S1). Next, the inflatable material 126 is inflated by the inflating device 129 to expand the inflatable material 126 (step S2). The expanded inflatable material 126 strikes the housing 124 to separate the housing 124 and the parachute 128 from the drone main body 110, and a distance between the parachute 128, which is connected to the housing 124 and the inflatable material 126, and the drone main body 110 is increased and the parachute 128 is driven to be deployed (step S3).

The operation timing of the parachute module 120 will be described in detail in the following. The drone 100 in this embodiment further includes a first sensing module 130 (shown in FIG. 1). The first sensing module 130 includes, for example, a first sensor 130a, such as a gyroscope and/or magnetometer, and a processor 130b. The first sensing module 130 is disposed on the drone main body 110 and is configured to sense a velocity, an acceleration and an inclination angle, etc., of the drone main body 110 to generate a sensing signal. Through the sensing signal, the processor 130b of the first sensing module 130 determines a current flight status of the drone 100 and generate a flight signal. By means of electrical connection, the parachute module 120 may receive the flight signal from the first sensing module 130, so that the inflating device 129 inflates the inflatable material 126 to deploy the parachute 128. To be specific, according to the sensing signal of the first sensing module 130, the flight status of the drone main body 110 may be recognized, for example, whether the drone 100 is flying or whether the drone 100 is stalled. Afterwards, the processor 130b of the first sensing module 130 determines whether to send the flight signal to the controller 127 of the parachute module 120 to control the inflating device 129 to inflate the inflatable material 126, so that the parachute 128 is deployed.

Referring to FIG. 2, in this embodiment, the parachute module 120 may further include at least one locking assembly 125. The locking assembly 125 is disposed on the base 122 and is configured to lock the housing 124 on the base 122. When the first sensing module 130 senses the flight status of the drone 100 (such as at least one of the inclination angle and the acceleration) and recognizes that the drone 100 is stalled, the first sensing module 130 will send the flight signal to the parachute module 120, and control the at least one locking assembly 125 to unlock and release the housing 124. And then, as described above, the parachute module 120 control the inflating device 129 to inflate the inflatable material 126, so that the parachute 128 is deployed. The locking assembly 125 is, for example, a buckle device or a lock. The locking assembly 125 may lock and release the housing 124 by any suitable locking mechanism, and the specific form is not limited by the disclosure.

In other embodiments, a controller included in the parachute module 120 per se may also be employed for determining and controlling as described above, which will be specifically explained in the following.

FIG. 6 is a schematic diagram of control of the parachute module. After the drone 100 takes off, the first sensing module 130 is prioritized to control the operation of the parachute module 120. However, when the first sensing module 130 cannot operate due to some factors (for example, the first sensor 130a or the processor 130b is damaged or loss of driving power), the controller 127 of the parachute module 120 will control the internal operation of the parachute module 120. The parachute module 120 in this embodiment, as shown in FIG. 2 and FIG. 6, the controller 127 further includes a second sensor 127a and a determiner 127b. The second sensor 127a may include a gyroscope and/or a magnetometer, and is configured to sense the flight status, such as the velocity, the acceleration, and the inclination angle of the drone main body 110. The determiner 127b is configured to recognize whether the drone 100 is flying or whether the drone 100 is stalled according to the sensing signal of the flight status of the drone main body 110 sensed by the second sensor 127a. And the determiner 127b is also configured to determine whether it is necessary to control the inflating device 129 to inflate the inflatable material 126 according to the sensing signal, so that the parachute 128 is deployed.

In other words, when the first sensing module 130 (shown in FIG. 1) and the controller 127 (shown in FIG. 6) are provided at the same time, the flight status sensed by the first sensing module 130 may be prioritized to serve as a basis for determining whether to activate the parachute module 120. In addition, when the first sensing module 130 of the drone main body 110 and a determination mechanism thereof are turned off or fail, the second sensor 127a and the determiner 127b of the controller 127 may serve as backups and replacements.

In an embodiment, the parachute module 120 may first recognize whether the drone 100 is flying according to the velocity of the drone main body 110 sensed by the first sensor 130a, and accordingly determine whether to activate the processor 130b. If the first sensor 130a senses that the velocity of the drone main body 110 is lower than a predetermined value, it means that the drone 100 has not taken off, and the processor 130b will not be activated at that time. In another embodiment, if the first sensor 130a fails, the parachute module 120 may first recognize whether the drone 100 is flying according to the velocity of the drone main body 110 sensed by the second sensor 127a, and accordingly determine whether to activate the determiner 127b. If the second sensor 127a senses that the velocity of the drone main body 110 is lower than the predetermined value, it means that the drone 100 has not taken off, and the determiner 127b will not be activated at that time. In this way, it is possible to prevent the processor 130b or the determiner 127b from erroneously triggering the operation of the parachute module 120 when the drone 100 has not taken off. If the first sensor 130a senses that the velocity of the drone main body 110 is higher than the predetermined value, it means that the drone 100 is flying, and the processor 130b is activated at that time. If the first sensor 130a fails and the second sensor 127a senses that the velocity of the drone main body 110 is higher than the predetermined value, it means that the drone 100 is flying, and the determiner 127b is activated at that time.

After the processor 130b is activated, it may recognize whether the drone 100 is stalled according to at least one of the inclination angle and the acceleration of the drone main body 110 sensed by the first sensor 130a. And accordingly, the processor 130b may determine whether to control the inflating device 129 to inflate the inflatable material 126, so that the parachute 128 is deployed. If the first sensor 130a fails, and the determiner 127b is activated, the determiner 127b may recognize whether the drone 100 is stalled according to at least one of the inclination angle and the acceleration of the drone main body 110 sensed by the second sensor 127a, and accordingly determine whether to control the inflating device 129 to inflate the inflatable material 126. If the drone 100 is stalled, the inflating device 129 is controlled to inflate the inflatable material 126 by the determiner 127b, so that the parachute 128 is deployed.

Referring to FIGS. 2 and 6, the determiner 127b shown in FIG. 6 may recognize whether the drone 100 is stalled according to the flight status (such as at least one of the inclination angle and the acceleration) of the drone main body 110 sensed by the second sensor 127a, and accordingly determine whether to control the locking assembly 125 to release the housing 124. If the drone 100 is stalled, the locking assembly 125 is controlled to release the housing 124, and the inflating device 129 is controlled to inflate the inflatable material 126 by the determiner 127b, so that the parachute 128 is deployed, as described above. The locking assembly 125 may lock and release the housing 124 by any suitable locking mechanism, and the specific form is not limited by the disclosure.

The processor 130b and determiner 127b may be, for example, a central processing unit (CPU), any other general-purpose or special-purpose programmable microprocessor, a digital signal processor (DSP), a programmable controller, an application specific integrated circuit (ASIC), a programmable logic device (PLD), or any other similar device or a chip of a combination of these devices.

In summary of the foregoing, in the drone of the disclosure, when the parachute module initiates the operation, the inflatable material expands and drives the parachute to be ejected so that the parachute is separated from the drone main body at a suitable distance. It is accordingly possible to prevent that the parachute is unable to be smoothly deployed due to unexpected entangling with the drone main body or the rotor blades. In addition, the housing configured to contain the parachute and the inflatable material moves along with the parachute as the inflatable material expands during the operation of the parachute module, which has the guiding effect of the deployment of the parachute. In this way, it may ensure that the parachute of the drone functions smoothly, and the time required for the full deployment of the parachute may be reduced.

The foregoing description of the preferred of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A drone, comprising a drone main body and a parachute module, wherein
the parachute module comprises a base, a housing, an inflatable material, a parachute, and an inflating device, wherein
the base is disposed on the drone main body;
the housing covers the base to form a containing space between the housing and the base;
the inflatable material is disposed on the base and is furled in the containing space;
the parachute is connected to the inflatable material and the housing and is furled in the containing space; and
the inflating device is disposed on the base and is connected to the inflatable material, wherein when the inflating device inflates the inflatable material, the inflatable material expands and strikes the housing to separate the housing from the drone main body, a distance between the parachute and the drone main body is increased and the parachute is driven to be deployed.

2. The drone according to claim 1, wherein the inflatable material expands into a column after being inflated by the inflating device.

3. The drone according to claim 1, wherein an outer surface of the housing is a convex curved surface.

4. The drone according to claim 1, further comprising a first sensing module, wherein the first sensing module is disposed on the drone main body and is configured to sense a flight status of the drone main body, and the parachute module is configured to determine whether to control the inflating device to inflate the inflatable material according to the flight status of the drone main body sensed by the first sensing module.

5. The drone according to claim 4, wherein the first sensing module comprises a first sensor and a processor, the first sensor is configured to sense the flight status of the drone main body, and the processor is configured to determine whether to control the inflating device to inflate the inflatable material according to the flight status of the drone main body sensed by the first sensor.

6. The drone according to claim 5, wherein the parachute module is configured to determine whether to activate the processor according to a velocity of the drone main body sensed by the first sensor.

7. The drone according to claim 1, wherein the parachute module comprises a second sensor and a determiner, the second sensor is configured to sense a flight status of the drone main body, and the determiner is configured to determine whether to control the inflating device to inflate the inflatable material according to the flight status of the drone main body sensed by the second sensor.

8. The drone according to claim 1, wherein the parachute module further comprises a locking assembly, and the locking assembly is disposed on the base and is configured to lock the housing on the base.

9. The drone according to claim 8, further comprising a first sensing module, wherein the first sensing module comprises a first sensor and a processor, the first sensor is configured to sense a flight status of the drone main body, and the processor is configured to determine whether to control the locking assembly to release the housing according to the flight status of the drone main body sensed by the first sensor.

10. The drone according to claim 8, wherein the parachute module comprises a second sensor and a determiner, the second sensor is configured to sense a flight status of the drone main body, and the determiner is configured to determine whether to control the locking assembly to release the housing according to the flight status of the drone main body sensed by the second sensor.

11. A control method of a drone, the method comprising:
disposing a parachute module on a drone main body, wherein the parachute module comprises an inflating device, an inflatable material, a housing, and a parachute;
inflating the inflatable material by the inflating device to expand the inflatable material; and
striking the housing by the inflatable material which is expanded to separate the housing and the parachute from the drone main body, a distance between the parachute which is connected to the housing and the inflatable material and the drone main body is increased, and the parachute is driven to be deployed.

12. The control method according to claim 11, further comprising:
sensing a flight status of the drone main body by a first sensing module of the drone main body; and
determining whether to control the inflating device to inflate the inflatable material by the parachute module according to the flight status of the drone main body sensed by the first sensing module.

13. The control method according to claim 12, further comprising:
sensing the flight status of the drone main body by a first sensor of the first sensing module; and
determining whether to control the inflating device to inflate the inflatable material by a processor of the first sensing module according to the flight status of the drone main body sensed by the first sensor.

14. The control method according to claim 13, wherein the first sensing module determines whether to activate the processor according to a velocity of the drone main body sensed by the first sensor.

15. The control method according to claim 12, further comprising:
sensing the flight status of the drone main body by a second sensor of the parachute module; and
determining whether to control the inflating device to inflate the inflatable material by a determiner of the parachute module according to the flight status of the drone main body sensed by the second sensor.

16. The control method according to claim 15, wherein the parachute module determines whether to activate the determiner according to a velocity of the drone main body sensed by the second sensor.

17. The control method according to claim 16, wherein the determiner determines whether to control the inflating device to inflate the inflatable material according to at least one of an inclination angle and an acceleration of the drone main body sensed by the second sensor.

18. The control method according to claim 12, further comprising locking the housing by a locking assembly.

19. The control method according to claim 18, further comprising:
sensing the flight status of the drone main body by a first sensor of the first sensing module; and
determining whether to control the locking assembly to release the housing by a processor of the first sensing module according to the flight status of the drone main body sensed by the first sensor.

20. The control method according to claim 18, further comprising:
sensing the flight status of the drone main body by a second sensor of the parachute module; and
determining whether to control the locking assembly to release the housing by a determiner of the parachute module according to the flight status of the drone main body sensed by the second sensor.
